(19) United States
(12) Patent Application Publication
(10) Pub. No.: US 2023/0195808 A1
(43) Pub. Date: Jun. 22, 2023

(54) SYSTEM AND METHOD FOR FACILITATING SOCIAL NETWORKING TO BUILD USER CONNECTION

(71) Applicant: Posse Global Inc., Costa Mesa, CA (US)

(72) Inventor: Brooke Sloman, Costa Mesa, CA (US)

(21) Appl. No.: 17/552,521

(22) Filed: Dec. 16, 2021

(51) Int. Cl. G06F 16/9535; G06F 16/9537; G06F 16/9538

(52) U.S. Cl. CPC G06F 16/9535; G06F 16/9537; G06F 16/9538

(57) ABSTRACT

A system for facilitating social networking and group dating is disclosed. A profile generation module generates a profile of a user, creates a group of users called a posse based on personal user information and invitations from posse members. A posse matching module identifies specific posse or the group of posse in a predefined radius of a geolocation based on activation of a beacon signal, determines a plurality of matching parameters between the active user or the group of posse and another posse, matches the active user or the group of posse with another posse. A user interaction handling module enables the active user or the group of the posse and another posse to interact with each other through one or more interaction options, displays the one or more interaction options on a messaging screen of a graphical user interface. An event notification module notifies the active user or the group of the posse and another posse about one or more personalised details.

### BACKGROUND

Embodiments of the present disclosure relate to a social media platform and more particularly to a system and a method for facilitating social networking to build user connection.

Social media networks are designed to facilitate communication between individual member users for a variety of purposes, for example, professional networking, connecting with others having common interests, or romantic ventures such as dating, to name a few. The dawn of the internet age has seen a proliferation of the social media networks designed to bring individual users to a physical meeting by facilitating first communication through the respective social media network. Users of the social media networks, dating applications, dating websites, and community forums may use the selected platform to meet other users having similar preferences, activities, and so on. Currently these types of platforms

Conventionally, the system available for facilitating social networking allow users to search for other users based on location, username, or a specific preference e.g., college attended, occupation, height, hair colour, age, etc. The platforms that allow a user to search other users based on location typically determine location based on a user's inputted location or by automatically detecting a user's location, such as through a location sensor, such as a global positioning system (GPS). However, these platforms do not differentiate users that live near or around a location and those that are visiting the location for building social interaction. Also, such conventional systems provide one-on-one dating which can be awkward, uncomfortable for holding a conversation with some unknown people. Moreover, an individual may face the risks of being catfished and meeting up with a stranger for the first time which is sometimes scary. Furthermore, social interaction for mixing, hanging out with friends or dating with people becomes monotonous and uncomfortable.

Hence, there is a need for an improved system and a method for facilitating social networking to build user connection in order to address the aforementioned issues.

### BRIEF DESCRIPTION

In accordance with an embodiment of the present disclosure, a system for facilitating social networking to build user connection is disclosed. The system includes a processing hosted on a server and configured to execute on a network to control bidirectional communications among a plurality of modules. The processing subsystem includes a profile generation module configured to generate a profile of a user by receiving personal user information through a communication interface. The profile generation module is also configured to create a group of posse based on each of the personal user information received from the user. The processing subsystem also includes a posse matching module configured to identify an active user or the group of posse in a predefined radius of a geolocation based on activation of a beacon signal for a predetermined period. The posse matching module is also configured to determine a plurality of matching parameters between the active user or the group of posse and another posse within the predefined radius of the geo-location based on activation of the beacon signal. The posse matching module is also configured to match the active user or the group of posse with the another posse in the predefined radius of the geo-location based on the plurality of matching parameters determined. The processing subsystem also includes a user interaction handling module configured to enable the active user or the group of the posse and another posse to interact with each other respectively in real-time, upon matching, through one or more interaction options. The user interaction module is also configured to display the one or more interaction options between the active user or the group of the posse and another posse on a messaging screen of a graphical user interface, wherein the one or more interaction options are received based on a user selection obtained from the graphical user interface. The processing subsystem also includes an event notification module configured to notify the active user or the group of the posse and another posse about one or more personalised details on the graphical user interface.

In accordance with another embodiment of the present disclosure, a method for facilitating social networking to build user connection is disclosed. The method includes generating, by a profile generation module of a processing subsystem, a profile of a user by receiving personal user information through a communication interface. The method also includes creating, by the profile generation module of the processing subsystem, a group of posse based on each of the personal user information received from the user. The method also includes identifying, by a posse matching module of the processing subsystem, an active user or the group of posse in a predefined radius of a geolocation based on activation of a beacon signal for a predetermined period. The method also includes determining, by the posse matching module of the processing subsystem, a plurality of matching parameters between the active user or the group of posse and another posse within the predefined radius of the geo-location based on activation of the beacon signal. The method also includes matching, by the posse matching module of the processing subsystem, the active user or the group of posse with the another posse in the predefined radius of the geo-location based on the plurality of matching parameters determined. The method also includes enabling, by a user interaction module of the processing subsystem, the active user or the group of the posse and another posse to interact with each other respectively in real-time, upon matching, through one or more interaction options. The method also includes displaying, by the user interaction module of the processing subsystem, the one or more interaction options between the active user or the group of the posse and another posse on a messaging screen of a graphical user interface, wherein the one or more interaction options are received based on a user selection obtained from the graphical user interface. The method also includes notifying, by an event notification module of the processing subsystem, the active user or the group of the posse and another posse about one or more personalised details on the graphical user interface.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered. limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for facilitating social networking to build user connection in accordance with an embodiment of the present disclosure;

FIG. 2 illustrates a schematic representation of an exemplary embodiment of a system for facilitating social networking to build user connection of FIG. 1 in accordance with an embodiment of the present disclosure;

FIG. 3 is a block diagram of a computer or a server in accordance with an embodiment of the present disclosure; and

FIG. 4(a) and FIG. 4(b) is a flow chart representing the steps involved in a method for facilitating social networking to build user connection in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be trrade to a number of terms, which shall be defined to have the following meanings. The singular forms “a”, “an”, and “the” include plural references unless the context clearly dictates otherwise.

Embodiments of the present disclosure relate to a system and a method for facilitating social networking to build user connection. The system includes a processing hosted on a server and configured to execute on a network to control bidirectional communications among a plurality of modules. The processing subsystem includes a profile generation module configured to generate a profile of a user by receiving personal user information through a communication interface. The profile generation module is also configured to create a group of posse based on each of the personal user information received from the user. The processing subsystem also includes a posse matching module configured to identify an active user or the group of posse in a predefined radius of a geolocation based on activation of a beacon signal for a predetermined period. The posse matching module is also configured to determine a plurality of matching parameters between the active user or the group of posse and another posse within the predefined radius of the geo-location based on activation of the beacon signal. The posse matching module is also configured to match the active user or the group of posse with the another posse in the predefined radius of the geo-location based on the plurality of matching parameters determined. The processing subsystem also includes a user interaction handling module configured to enable the active user or the group of the posse and another posse to interact with each other respectively in real-time, upon matching, through one or more interaction options. The user interaction module is also configured to display the one or more interaction options between the active user or the group of the posse and another posse on a. messaging screen of a graphical user interface, wherein the one or more interaction options are received based on a user selection obtained from the graphical user interface. The processing subsystem also includes an event notification module configured to notify the active user or the group of the posse and another posse about one or more personalised details on the graphical user interface.

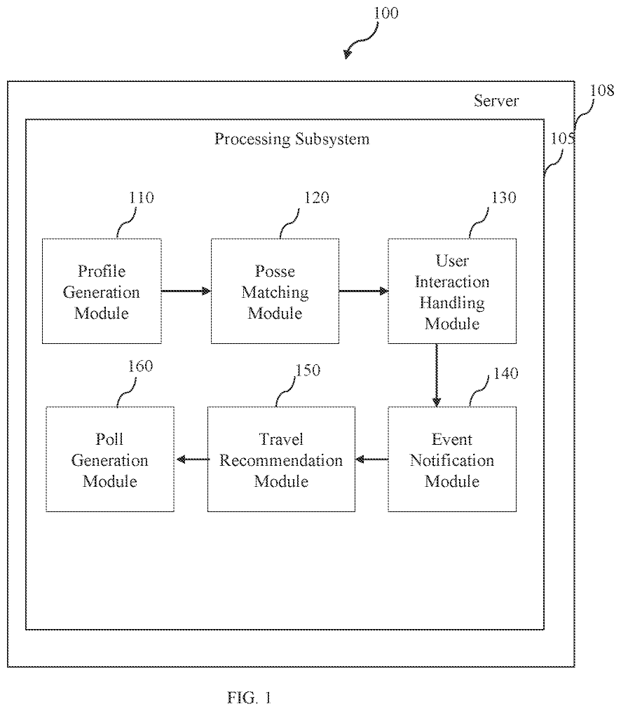

FIG. 1 is a block diagram of a system 100 for facilitating social networking to build user connection in accordance with an embodiment of the present disclosure. The system 100 includes a processing subsystem 105 hosted on a server 108 and configured to execute on a network to control bidirectional communications among a plurality of modules. In one embodiment, the server 108 may include a cloud server. In another embodiment, the server 108 may include a local server. The processing subsystem 105 is configured to execute on a network to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a profile generation module 110 configured to generate a profile of a user by receiving personal user information through a communication interface. The profile generation module 110 is also configured to create a group of posse based on each of the personal user information received from the user. In one embodiment, the personal user information may include at least one of a name of a user, a contact details of the user, an address of the user, an interest of the user, a photo of the user, a plan of the user or a combination thereof. As used herein, the term ‘group of posse’ is defined as group of users or friends formed for social interaction.

The processing subsystem 105 also includes a posse matching module 120 configured to identify an active user or the group of posse in a predefined radius of a geolocation based on activation of a beacon signal for a predetermined period. As used herein, the term ‘beacon signal’ is defined as a radio signal transmitted by a wireless device for communicating with a nearby wireless device. In one embodiment, the geolocation may include a latitude and a longitude location data.

The posse matching module 120 is also configured to determine a plurality of matching parameters between the active user or the group of posse and another posse within the predefined radius of the geo-location based on activation of the beacon signal. In some embodiment, the plurality of matching parameters may include at least one of interests of the posses, ratio of relationship status of the posses, geographical location of the posses, gender of the posses, preference of the posses, posse size, upcoming trips of the posses, historical travel location of the posses or a combination thereof. The posse matching module 120 is also configured to match the active user or the group of posse with the another posse in the predefined radius of the geolocation based on the plurality of matching parameters determined.

The processing subsystem 105 also includes a user interaction handling module 130 configured to enable the active user or the group of the posse and another posse to interact with each other respectively in real-time, upon matching, through one or more interaction options. In one embodiment, the one or more interaction options may include al least one of messages, chats, likes, comments, posts or a combination thereof. The user interaction handling module 130 is also configured to display the one or more interaction options between the active user or the group of the posse and another posse on a messaging screen of a graphical user interface (GUI), wherein the one or more interaction options are received based on a user selection obtained from the graphical user interface. In a specific embodiment, the user interaction module is configured to receive the one or more interaction options based on the user selection performed on the graphical user interface by the active user or the group of the posse and another posse. In some embodiment, the user selection comprises at least one of a mouse click, a press of a button, a swiping gesture or a combination thereof

The processing subsystem 105 also includes an event notification module 140 configured to notify the active user or the group of the posse and another posse about one or more personalised details on the graphical user interface. For example, the GUI may include a user interactive component of an electronic device. Also, in such an example, the electronic device may include, but not limited to, a mobile phone, a laptop, a desktop, a tablet, a personal digital assistant (PDA) and the like.

Here, the one or more personalised details includes at least one of relationship status of the posse, one or more upcoming events, an incoming message, an incoming posse request, a matching posse notification or a combination thereof. For example, the relationship status of the posse is represented on the graphical user interface in a first colour, a second colour and a third colour respectively. In such example, the first colour is representative of a single relationship status, the second colour is representative of a complicated relationship status, the third colour is representative of an engaged relationship status.

The processing subsystem 105 further includes a travel recommendation module 150 configured to provide at least one of a travel recommendation, an accommodation recommendation, a food recommendation, an activity recommendation or a combination thereof to the active user or the group of the posse and the another posse.

In addition, the processing subsystem 105 further includes a poll generation module 160 operatively coupled to the travel recommendation module 150. In such embodiment, the poll generation module is configured to enable the active user or the group of posse and the another posse upon matching to vote on the one or more upcoming events with suggestion of a plurality of feasible dates and times. In a particular embodiment, the method further includes providing, by a travel recommendation module, at least one of a travel recommendation, an accommodation recommendation, a food recommendation, an activity recommendation or a combination thereof to the active user or the group of the posse and the another posse. In another particular embodiment, the method further includes enabling, by a poll generation module, the active user or the group of posse and the another posse upon matching to vote on the one or more upcoming events with suggestion of a plurality of feasible dates and times.

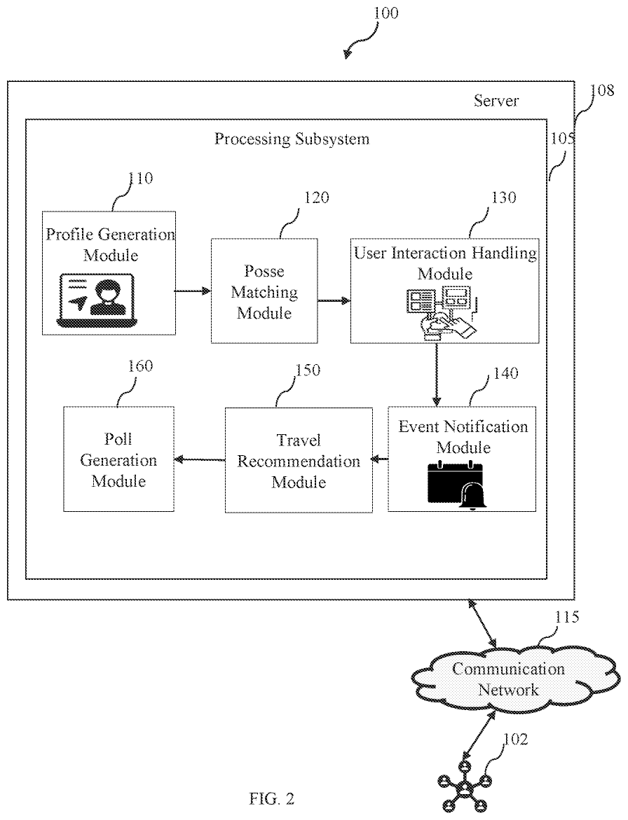

FIG. 2 illustrates a schematic representation of an exemplary embodiment of a system for facilitating social networking to build user connection of FIG. 1 in accordance with an embodiment of the present disclosure. Considering an example, wherein the system 100 is utilised in a society by a user or a group of users 102 to interact with unknown users, establishing friendship with them and finally mixing with such unknown group of users to either socialize or date with them. The system 100 for building the user connection, receives personal user information by a profile generation module 110, wherein the profile generation module 110 is located on a processing subsystem 105 which is hosted on a cloud server 108. Here, the processing subsystem 105 communicates with various modules through a wireless communication network 115. Once, the personal user information is received, the profile generation module 110 generates a profile of a user. In the example used herein, the personal information may include at least one of a name of a user, a contact details of the user, an address of the user, an interest of the user, a photo of the user, a plan of the user or a combination thereof Also, profile generation module 110 creates a group of posse based on each of the personal user information received from the user.

Upon generation of the profile of the user, a posse matching module 120 identifies an active user or the group of posse in a predefined radius of a geolocation based on activation of beacon signal for a predetermined period. Also, the posse matching module 120 determines a plurality of matching parameters between the active user or the group of posse and another posse within the predefined radius of the geo-location based on activation of the beacon signal.

For example, the plurality of thatching parameters may include at least one of interests of the posses, ratio of relationship status of the posses, geographical location of the posses, gender of the posses, preference of the posses, posse size, upcoming trips of the posses, historical travel location of the posses or a combination thereof. The posse matching module 120 also matches the active user or the group of posse with the another posse in the predefined radius of the geo-location based on the plurality of matching parameters determined.

Once, the posse is matched, a user interaction handling module 130 enable the active user or the group of the posse and another posse to interact with each other respectively in real-time, upon matching, through one or more interaction options. In the example used herein, the one or more interaction options may include at least one of messages, chats, likes, comments, posts or a combination thereof. The user interaction handling module 130 is also configured to display the one or more interaction options between the active user or the group of the posse and another posse on a messaging screen of a graphical user interface (GUI), wherein the one or more interaction options are received based on a user selection obtained from the graphical user interface. In a specific example, the user interaction handling module 130 is configured to receive the one or more interaction options based on the user selection performed on the graphical user interface by the active user or the group of the posse and another posse.

In addition, an event notification module 140 notify the active user or the group of the posse and another posse about one or more personalised details on the graphical user interface. In one embodiment, the GUI may include a user interactive component of an electronic device. In such embodiment, the electronic device may include, but not limited to, a mobile phone, a laptop, a desktop, a tablet, a personal digital assistant (PDA) and the like. Here, the one or more personalised details includes at least one of relationship status of the posse, one or more upcoming events, an incoming message, an incoming posse request, a matching posse notification or a combination thereof For example, the relationship status of the posse is represented on the graphical user interface in a first colour, a second colour and a third colour respectively. In such example, the first colour is representative of a single relationship status, the second colour is representative of a complicated relationship status, the third colour is representative of an engaged relationship status.

The processing subsystem 105 further includes a travel recommendation module 150 configured to provide at least one of a travel recommendation, an accommodation recommendation, a food recommendation, an activity recommendation or a combination thereof to the active user or the group of the posse and the another posse.

In addition, the processing subsystem 105 further includes a poll generation module 160 operatively coupled to the travel recommendation module 150. In such embodiment, the poll generation module is configured to enable the active user or the group of posse and the another posse upon matching to vote on the one or more upcoming events with suggestion of a plurality of feasible dates and times. In a particular embodiment, the method further includes providing, by a travel recommendation module, at least one of a travel recommendation, an accommodation recommendation, a food recommendation, an activity recommendation or a combination thereof to the active user or the group of the posse and the another posse. In another particular embodiment, the method further includes enabling, by a poll generation module, the active user or the group of posse and the another posse upon matching to vote on the one or more upcoming events with suggestion of a plurality of feasible dates and times.

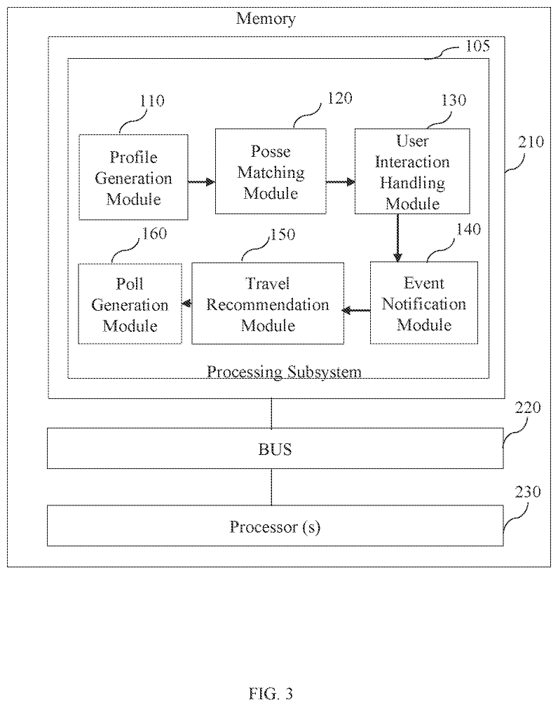

FIG. 3 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a profile generation module 110, a posse matching module 120, a user interaction handling module 130 and an event notification module 140.

The profile generation module 110 configured to generate a profile of a user by receiving personal user information through a communication interface. The profile generation module 110 is also configured to create a group of posse based on each of the personal user information received from the user. The posse matching module 120 is configured to identify an active user or the group of posse in a predefined radius of a geolocation based on activation of a beacon signal for a predetermined period. The posse matching module 120 is also configured to determine a plurality of matching parameters between the active user or the group of posse and another posse within the predefined radius of the geo-location based on activation of the beacon signal. The posse matching module 120 is also configured to match the active user or the group of posse with the another posse in the predefined radius of the geo-location based on the plurality of matching parameters determined. The user interaction handling module 130 is configured to enable the active user or the group of the posse and another posse to interact with each other respectively in real-time, upon matching, through one or more interaction options. The user interaction handling module 130 is also configured to display the one or more interaction options between the active user or the group of the posse and another posse on a messaging screen of a graphical user interface, wherein the one or more interaction options are received based on a user selection obtained from the graphical user interface. The event notification module 140 is configured to notify the active user or the group of the posse and another posse about one or more personalised details on the graphical user interface.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

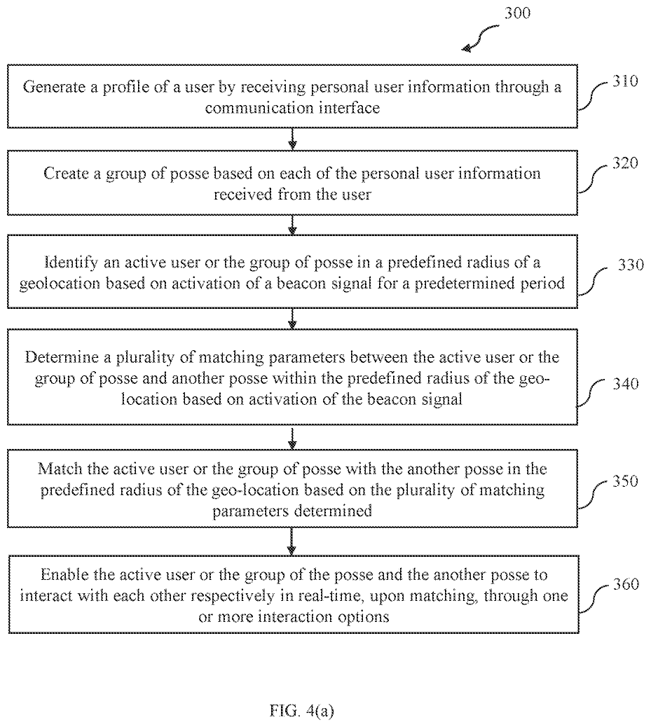

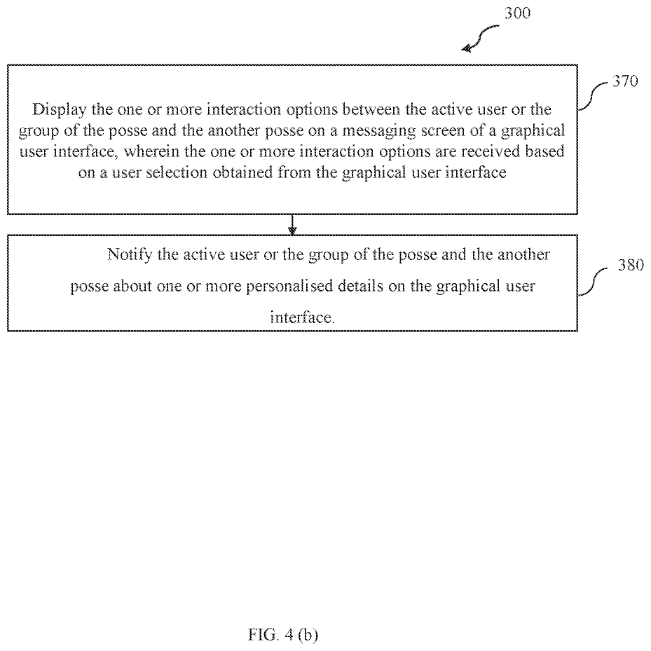

FIG. 4 (a) and FIG. 4 (b) is a flow chart representing the steps involved in a method 300 for facilitating social networking to build user connection in accordance with the embodiment of the present disclosure. The method 300 includes generating, by a profile generation module of a processing subsystem, a profile of a user by receiving personal user information through a communication interface in step 310. In one embodiment, generating the profile of the user may include generating the profile of the user by receiving the personal user information including, but not limited to, at least one of a name of a user, a contact details of the user, an address of the user, an interest of the user, a photo of the user, a plan of the user or a combination thereof. The method 300 also includes creating, by the profile generation module of the processing subsystem, a group of posse based on each of the personal user information received from the user in step 320.

The method 300 also includes identifying, by a posse matching module of the processing subsystem, an active user or the group of posse in a predefined radius of a. geolocation based on activation of a beacon signal for a predetermined period in step 330. In some embodiment, identifying the active user or the group of posse in the predefined radius of the geolocation based on activation of a beacon signal may include identifying the active user or the group of posse in the predefined radius of the geolocation having a latitude and a longitude location data.

The method 300 also includes determining, by the posse matching module of the processing subsystem, a plurality of matching parameters between the active user or the group of posse and another posse within the predefined radius of the geo-location based on activation of the beacon signal in step 340. In one embodiment, determining the plurality of matching parameters between the active user or the group of the posse and another posse may include determining at least one of interests of the posses, ratio of relationship status of the posses, geographical location of the posses, gender of the posses, preference of the posses, posse size, upcoming trips of the posses, historical travel location of the posses or a combination thereof.

The method 300 also includes matching, by the posse matching module of the processing subsystem, the active user or the group of posse with the another posse in the predefined radius of the geo-location based on the plurality of matching parameters determined in step 350. In one embodiment, matching the active user or the group of the posse with the another posse in the predefined radius based on the plurality of parameters may include matching the active user or the group of the posse with the another posse based on at least one of interests of the posses, ratio of relationship status of the posses, geographical location of the posses, gender of the posses, preference of the posses, posse size, upcoming trips of the posses, historical travel location of the posses or a combination thereof

The method 300 also includes enabling, by a user interaction module of the processing subsystem, the active user or the group of the posse and another posse to interact with each other respectively in real-time, upon matching, through one or more interaction options in step 360. The method 300 also includes displaying, by the user interaction module of the processing subsystem, the one or more interaction options between the active user or the group of the posse and another posse on a messaging screen of a graphical user interface, wherein the one or more interaction options are received based on a user selection obtained from the graphical user interface in step 370. In some embodiment, the one or more interaction options may include at least one of messages, chats, likes, comments, posts or a combination thereof.

The method 300 also includes notifying, by an event notification module of the processing subsystem, the active user or the group of the posse and another posse about one or more personalised details on the graphical user interface in step 380. In one embodiment, notifying the active user or the group of the posse and another posse about the one or more personalised details may include notifying the one or more personalised details including atleast one of relationship status of the posse, one or more upcoming events, an incoming message, an incoming posse request, a matching posse notification or a combination thereof. In sonic embodiment, the relationship status of the posse is represented on the graphical user interface in a first colour, a second colour and a third colour respectively. In such embodiment, the first colour is representative of a single relationship status, the second colour is representative of a complicated relationship status, the third colour is representative of an engaged relationship status.

Various embodiments of the present disclosure provide a system which makes user connection for social networking easy, comfortable, and unawkward by enabling one to one dating and meeting with people easier.

Moreover, such a conventional system allows groups of people to get together to break the ice and make dating or socializing a fun filled activity. The system also overcomes problems like people not turning up, where if one group doesn't show up, but another group of people are interested to hang out with friends.

It will be understood by those skilled in the art that the foregoing general description and the following detailed description are exemplary and explanatory of the disclosure and are not intended to be restrictive thereof

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown nor do all of the acts need to be necessarily performed. Also, those acts that are not dependent on other acts may be performed in parallel with the other acts. The scope of embodiments is by no means limited by these specific examples.

We claim:

1. A system for facilitating social networking to build user connection, the system comprises:
a processor, and
a memory coupled to the processor, wherein the memory comprises a set of program instructions in the form of a plurality of modules, configured to be executed by the processor, the plurality of modules comprises:
a profile generation module configured to:
generate a profile of a user by receiving personal user information through a communication interface; and
create a group of posse based on each of the personal user information received from the user, wherein the group of posse is a group of users or friends formed for social interaction;
a posse matching module configured to:
identify an active user or the group of posse in a predefined radius of a geolocation based on activation of a beacon signal for a predetermined period, wherein the beacon signal corresponds to a radio signal transmitted by a wireless device for communicating with a nearby wireless device;
determine a plurality of matching parameters between the active user or the group of posse and another group of posse within the predefined radius of the geo-location based on activation of the beacon signal, wherein the plurality of matching parameters comprises at least one of interests of the posses, ratio of relationship status of the posses, geographical location of the posses, gender of the posses, preference of the posses, posse size, upcoming trips of the posses, historical travel location of the posses or a combination thereof: and
match the active user or the group of posse with the another group of posse in the predefined radius of the geo-location based on the plurality of matching parameters determined;
a user interaction handling module is configured to:
enable the active user or the group of the posse and another group of posse to interact with each other respectively in real-time, upon matching, through one or more interaction options; and
display the one or more interaction options between the active user or the group of the posse and another group of posse on a messaging screen of a graphical user interface, wherein the one or more interaction options are received based on a user selection obtained from the graphical user interface;
a travel recommendation module configured to generate at least one of a travel recommendation, an accommodation recommendation, a food recommendation, and an activity recommendation to the active user , the group of the posse and the another group of posse; and
an event notification module configured to notify the active user or the group of the posse and another group of posse about one or more personalised details on the graphical user interface, and wherein the one or more personalised details comprises at least one of relationship status of the posse, one or more upcoming events, an incoming message, an incoming posse request, and a matching posse notification.

2. The system of claim 1, wherein the personal user information comprises at least one of a name of a user, a contact details of the user, an address of the user, an interest of the user, a photo of the user, a plan of the user or a combination thereof

3. The system of claim 1, wherein the geolocation comprises a latitude and a longitude location data.

4. (canceled)

5. The system of claim 1, wherein the one or more interaction options comprises at least one of messages, chats, likes, comments, posts or a combination thereof

6. The system of claim 1, wherein the user selection comprises at least one of a mouse click, a press of a button, a swiping gesture or a combination thereof

7. The system of claim 1, wherein the user interaction handling module is configured to receive the one or more interaction options based on the user selection performed on the graphical user interface by the active user or the group of the posse and another group of posse.

8. The system of claim 1, wherein the graphical user interface comprises a user interactive component of an electronic device.

9. (canceled)

10. The system of claim 1, wherein the relationship status of the posse is represented on the graphical user interface in a first colour, a second colour and a third colour respectively.

11. The system of claim 10, wherein the first colour is representative of a single relationship status, the second colour is representative of a complicated relationship status, the third colour is representative of an engaged relationship status.

12. (canceled)

13. (canceled)

14. A method for facilitating social networking to build user connection comprising:
generating, by a processor, a profile of a user by receiving personal user information through a communication interface;
creating, by the processor, a group of posse based on each of the personal user information received from the user, wherein the group of posse is a group of users or friends formed for social interaction;
identifying, by the processor, an active user or the group of posse in a predefined radius of a geolocation based on activation of a beacon signal for a predetermined period, wherein the beacon signal corresponds to a radio signal transmitted by a wireless device for communicating with a nearby wireless device;
determining, by the processor, a plurality of matching parameters between the active user or the group of posse and another group of posse within the predefined radius of the geo-location based on activation of the beacon signal, wherein the plurality of matching parameters comprises at least one of interests of the posses, ratio of relationship status of the posses, geographical location of the posses, gender of the posses, preference of the posses, posse size, upcoming trips of the posses, and historical travel location of the posses;
matching, by the processor, the active user or the group of posse with the another group of posse in the predefined radius of the geo-location based on the plurality of matching parameters determined;
enabling, by the processor, the active user or the group of the posse and another group of posse to interact with each other respectively in real-time, upon matching, through one or more interaction options;
displaying, by the processor, the one or more interaction options between the active user or the group of the posse and another group of posse on a messaging screen of a graphical user interface, wherein the one or more interaction options are received based on a user selection obtained from the graphical user interface;
generating, by the processor, at least one of a travel recommendation, an accommodation recommendation, a food recommendation, and an activity recommendation to the active user and the group of the posse and the another group of posse; and
notifying, by the processor, the active user or the group of the posse and another group of posse about one or more personalised details on the graphical user interface, and wherein the one or more personalised details comprises at least one of relationship status of the posse, one or more upcoming events, an incoming message, an incoming posse request, and a matching posse notification.
